(19) United States
(12) Patent Application Publication
(10) Pub. No.: US 2024/0047808 A1
(43) Pub. Date: Feb. 8, 2024

(54) FIXING DEVICE FOR BATTERY MODULES, BATTERY PACK AND VEHICLE

(71) Applicant: HONDA MOTOR CO., LTD., Tokyo (JP)

(72) Inventors: Yaozhong Huo, Guangzhou (CN); Shupei Fan, Guangzhou (CN)

(21) Appl. No.: 18/228,702

(22) Filed: Aug. 1, 2023

(30) Foreign Application Priority Data
Aug. 4, 2022 (CN) 202210931446.0

(51) Int. Cl. H01M 50/249; H01M 50/244; H01M 50/264; B60R 16/04

(52) U.S. Cl. CPC H01M 50/249; H01M 50/244; H01M 50/264; B60R 16/04; H01M 2220/20

(57) ABSTRACT

The present disclosure relates to technical field of electric vehicles and provides fixing device for battery modules, battery pack, and vehicle having the battery pack. The battery module is mounted on bottom plate having first cavity by the fixing device, and the bottom plate is provided with first mounting hole penetrating through the cavity wall of the first cavity. The fixing device includes mounting bracket extending in the length direction of the first cavity to be disposed in the first cavity, the length of the mounting bracket being approximately equal to that of the first cavity; restraining member mounted on the mounting bracket; and fixing member penetrating through the first mounting hole to be fixed to the restraining member so as to fix the battery module to the bottom plate. Thus, it is possible to improve the assembly efficiency of the restraining member in the bottom plate.

### CROSS-REFERENCE TO RELATED APPLICATION

Priority is claimed on Chinese Patent Application No. 202210931446.0, filed on Aug. 4, 2022, the contents of which are incorporated herein by reference.

### BACKGROUND OF THE INVENTION

### Field of the Invention

The present disclosure relates to the technical field of electric vehicles, and particularly relates to a fixing device for battery modules, a battery pack, and a vehicle having the battery pack.

### Description of Related Art

A battery pack can supply power to the power motor of an electric vehicle. Usually, a plurality of battery modules in the battery pack are fixed to the bottom plate of the shell of the battery pack, and bolts are generally used for the fixed connection of the battery module and the bottom plate. The bottom plate is generally made of aluminum, and if threaded holes made of aluminum are formed in the bottom plate, the threaded holes need to be formed with a larger depth in order to meet the strength requirement. However, some types of battery packs have a thin aluminum bottom plate that cannot meet the depth requirement of the threaded hole. Although it is possible to change the style of the bottom plate of the battery pack, since the bottom plate of the battery pack is in a style for mass production, it is difficult to change.

In order to meet the depth requirement of the threaded hole without changing the style of the bottom plate, it is possible to configure restraining members made of a material stronger than aluminum, such as nuts, in the bottom plate to fix the battery module in cooperation with fixing members, such as bolts. However, it is more difficult to configure and position smaller restraining members such as nuts in the bottom plate, and thus the assembly efficiency of the restraining member is low.

For this reason, improving the assembly efficiency of the restraining member in the bottom plate of the battery pack has become a technical problem that needs to be solved.

### SUMMARY OF THE INVENTION

In view of the above problems, the present disclosure aims to provide a fixing device for battery modules, a battery pack, and a vehicle having the battery pack, which can improve the assembly efficiency of restraining members in a bottom plate of the battery pack.

According to the first aspect, the present disclosure provides a fixing device for battery modules, in which a battery module is fixed to a bottom plate having a first cavity by the fixing device, and the bottom plate is provided with a first mounting hole penetrating through the cavity wall of the first cavity; the fixing device includes a mounting bracket extending in the length direction of the first cavity to be disposed in the first cavity, the length of the mounting bracket being approximately equal to that of the first cavity; a restraining member mounted on the mounting bracket; and a fixing member penetrating through the first mounting hole to be fixed to the restraining member so as to fix the battery module to the bottom plate.

Since the bottom plate has the first cavity, the mounting bracket extends to be disposed in the first cavity, the length of the mounting bracket is approximately equal to that of the first cavity, the mounting bracket is inserted into the first cavity, and the end of the mounting bracket is aligned with the end of the first cavity, positioning of the restraining member in the length direction of the first cavity can be achieved, thus simplifying the positioning process of the restraining member and improving the assembly efficiency of the restraining member in the bottom plate. In addition, the positioning of the restraining member can be easily achieved without disposing a special positioning structure, and the technical effects of a simple structure and a low manufacturing cost can be obtained.

In one implementation mode, the mounting bracket includes a plurality of first brackets arranged in a row in the length direction of the first cavity, with adjacent first brackets abutting against each other, and the sum of the lengths of the plurality of first brackets is approximately equal to the length of the first cavity.

Thus, the universality of the mounting bracket can be improved.

In one implementation mode, the mounting bracket is a monomer component.

Thus, it is possible to further improve the assembly efficiency of the restraining member in the bottom plate.

In one implementation mode, the battery modules are plural, the plurality of battery modules are arranged in more than one row, and the length direction of the first cavity is parallel to the arrangement direction of the battery modules in more than one row.

Thus, it is possible to efficiently carry out positioning of the restraining member, further improving the assembly efficiency of the restraining member in the bottom plate.

In one implementation mode, the plurality of battery modules are arranged in such a way that the long sides are parallel to each other and the short sides are on the same line, and the length direction of the first cavity is parallel to the short side of the battery module.

Thus, it is possible to reduce the number of first cavities required and the number of mounting brackets required.

In one implementation mode, the mounting bracket is of a hollow structure.

Thus, it is possible to reduce the weight while ensuring the strength of the mounting bracket.

In one implementation mode, the side edges of the mounting bracket in the length direction are provided with a supporting edge, and the supporting edge extends toward the first mounting hole or away from the first mounting hole.

Thus, it is possible to restrain the torsional deformation of the mounting bracket by means of the supporting edge.

In one implementation mode, the mounting bracket is provided with a mounting portion, the restraining member is mounted on the mounting portion, and the supporting edge is disposed on the side edge of the mounting portion on the mounting bracket.

Thus, it is possible to avoid a case where the weight of the mounting bracket increases excessively while the torsional deformation of the mounting bracket is restrained by means of the supporting edge, and it is possible to support the mounting portion by means of the supporting edge, improving the stability of the mounting portion.

In one implementation mode, the mounting bracket is provided with a mounting portion, the restraining member is mounted on the mounting portion, and the supporting edge is arranged on adjacent side edges of the mounting portion on the mounting bracket.

Thus, it is possible to avoid a case where the weight of the mounting bracket increases excessively while the torsional deformation of the mounting bracket is restrained by means of the supporting edge, and it is possible to avoid a case where the operation of mounting the restraining member on the mounting portion is hindered by the supporting edge.

In one implementation mode, the mounting bracket is provided with a plurality of mounting portions, the restraining member is mounted on the mounting portion, the mounting bracket is provided with a hollow portion, and the hollow portion is located between the adjacent mounting portions.

Thus, it is possible to reduce the weight of the mounting bracket.

In one implementation mode, the mounting bracket is provided with a reinforcing portion, and the reinforcing portion is located between the adjacent mounting portions.

Thus, it is possible to ensure the strength of the mounting bracket.

In one implementation mode, the hollow portion includes two edge portions extending in the length direction of the mounting bracket in parallel to each other, and the reinforcing portion includes a reinforcing rib connecting the two edge portions.

Thus, it is possible to reduce the weight while ensuring the strength of the mounting bracket.

In one implementation mode, the reinforcing portion includes a rib portion extending in the length direction of the mounting bracket, and in the length direction of the mounting bracket, the hollow portion and the mounting portion are located on opposite sides of the rib portion.

Thus, it is possible to reduce the weight while ensuring the strength of the mounting bracket.

In one implementation mode, the rib portion has a width smaller than that of the mounting portion, the supporting edges are disposed on both sides of the rib portion in the width direction of the mounting bracket, and the sum of the width of the rib portion and the width of the supporting edges on both sides is greater than or equal to the width of the mounting portion.

Thus, it is possible to reduce the width of the mounting bracket.

In one possible mode, the supporting edges include a pair of supporting edges disposed obliquely, and the pair of supporting edges extend, with the distance between them gradually increasing, from the side edge toward the first mounting hole or away from the first mounting hole.

Thus, the structure of the mounting bracket can be more stable, and the assembly operation of the mounting bracket in the first cavity can be easily performed.

In one possible mode, the first cavity is provided with an opening at least at one end in the length direction, and the mounting bracket is detachably inserted, from the opening, in the first cavity.

Thus, it is possible to improve the assembly flexibility of the mounting bracket in the first cavity.

In one possible mode, the material of the restraining member is steel.

Thus, it is possible to improve the fixing strength of the battery module.

In one possible mode, the restraining member is a nut, and the fixing member is a bolt.

Thus, it is possible to lower the requirement for the thread depth of the nut under the same strength requirement in the case where the steel nut is used. Therefore, it is also possible to dispose a nut capable of ensuring the strength in a bottom plate with a smaller thickness, and it is not needed to change the thickness of the bottom plate to meet the requirement for the depth of a threaded hole.

In the second aspect, the present disclosure provides a battery pack, including battery modules and a shell accommodating the battery modules, the shell including a bottom plate having first cavities, and the battery modules being fixed to the bottom plate by means of the fixing device for battery modules according to the first aspect or according to any implementation mode in the first aspect.

Thus, it is possible to simplify the positioning process of a restraining member and improve the assembly efficiency of the restraining member in the bottom plate when the battery modules are fixed to the bottom plate of the battery pack. In addition, the positioning of the restraining member can be easily achieved without disposing a special positioning structure, and the technical effects of a simple structure and a low manufacturing cost can be obtained.

According to the third aspect, the present disclosure provides a vehicle having the battery pack according to the second aspect.

Thus, it is possible to simplify the positioning process of a restraining member and improve the assembly efficiency of the restraining member in a bottom plate when a battery module is fixed to the bottom plate of the battery pack. In addition, the positioning of the restraining member can be easily achieved without disposing a special positioning structure, and the technical effects of a simple structure and a low manufacturing cost can be obtained.

These aspects and other aspects of the present application will be more clear and easier to understand from the description of the following (plurality of) embodiments.

### BRIEF DESCRIPTION OF THE DRAWINGS

FIG. 1 is a schematic view of the appearance of a battery pack provided in an embodiment of the present disclosure;

FIG. 2 is a structural schematic view of the battery pack provided in the embodiment of the present disclosure;

FIG. 3 is a partial cross-sectional view of the battery pack provided in the embodiment of the present disclosure;

FIG. 4 is an enlarged cross-sectional view of a part provided with a fixing device for battery modules;

FIG. 5 is a three-dimensional schematic view of a mounting bracket involved in Embodiment 1, viewed from the oblique upper portion;

FIG. 6 is a three-dimensional schematic view of the mounting bracket involved in Embodiment 1, viewed from the oblique lower portion;

FIG. 7 is a top view of the mounting bracket involved in Embodiment 1;

FIG. 8 is a side view of the mounting bracket involved in Embodiment 1;

FIG. 9 is a front view of the mounting bracket involved in Embodiment 1;

FIG. 10 is a three-dimensional schematic view of a mounting bracket involved in Embodiment 2, viewed from the oblique upper portion;

FIG. 11 is a three-dimensional schematic view of the mounting bracket involved in Embodiment 2, viewed from the oblique lower portion;

FIG. 12 is a front view of the mounting bracket involved in Embodiment 2;

FIG. 13 is a partially enlarged three-dimensional schematic view of the mounting bracket involved in Embodiment 2; and

FIG. 14 is an effect view of the mounting bracket involved in Embodiment 2.

### LIST OF REFERENCE NUMERALS

1: battery pack; 2: battery module; 3a: shell; 3b: upper cover; 4: lifting lug; 5: fixing device; 6: bolt; 7, 7a: mounting bracket; mounting bracket; 8: nut; 9: gasket; 20: battery cell; 21: second mounting hole; 30: side plate; 31: bottom plate; 60: rod portion; 61: threaded portion; 70: bracket portion; 71: hollow portion; 71a: edge portion; 72, 72a, 72b: mounting portion; 73, 73a: supporting edge; 74: reinforcing rib; 77: rib portion; 78: hollow portion; 310: first cavity; 311: second cavity; 312: third cavity; 314: first mounting hole; 720, 720a: through hole.

### DETAILED DESCRIPTION OF THE INVENTION

The present disclosure will be further described in detail below in conjunction with embodiments and with reference to the drawings. It is to be understood that the embodiments herein are only used for explaining the present disclosure and not intended to limit the present disclosure.

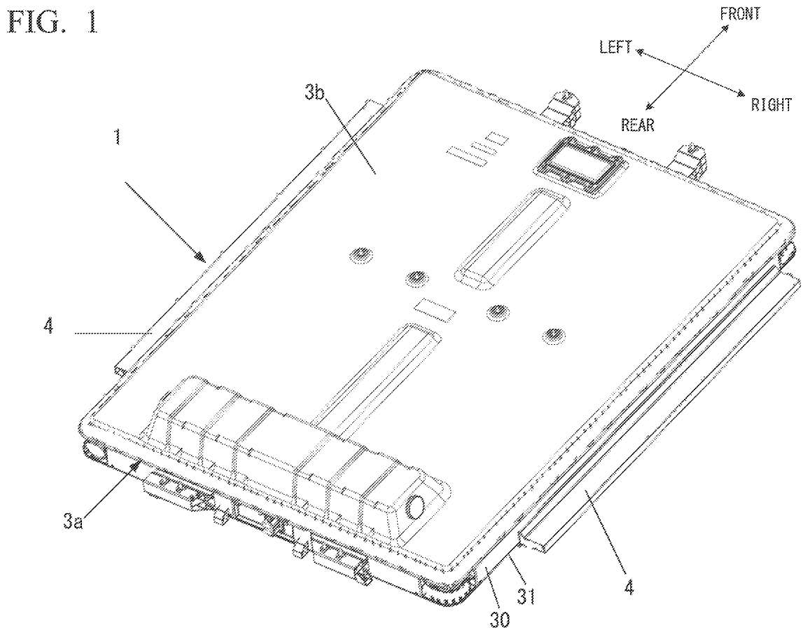

With reference to FIG. 1 to FIG. 9, an embodiment of the present disclosure provides a fixing device 5 for battery modules 2, in which a battery module 2 is fixed to a bottom plate 31 having a first cavity 310 by the fixing device 5, and the bottom plate 31 is provided with a first mounting hole 314 penetrating through the cavity wall of the first cavity 310; the fixing device 5 includes: a mounting bracket 7, a restraining member 8 and a fixing member 6, the mounting bracket 7 extends in the length direction of the first cavity 310 to be disposed in the first cavity 310, the length of the mounting bracket 7 is approximately equal to that of the first cavity 310, the restraining member 8 is mounted on the mounting bracket 7, and the fixing member 6 penetrates through the first mounting hole 314 to be fixed to the restraining member 8 so as to fix the battery module 2 to the bottom plate 31. In the present application, “approximately equal” means that the difference therebetween is below a certain value, for example, 10 mm, or the percentage of the difference therebetween is below a certain value, for example, 10%.

With this structure, since the bottom plate 31 has the first cavity 310, the mounting bracket 7 extends to be disposed in the first cavity 310, the length of the mounting bracket 7 is approximately equal to that of the first cavity 310, the mounting bracket 7 is inserted into the first cavity 310, and the end of the mounting bracket 7 is aligned with the end of the first cavity 310, positioning of the restraining member 8 in the length direction of the first cavity 310 can be achieved, thus simplifying the positioning process of the restraining member 8 and improving the assembly efficiency of the restraining member 8 in the bottom plate 31. In addition, the positioning of the restraining member 8 can be easily achieved without disposing a special positioning structure, and the technical effects of a simple structure and a low manufacturing cost can be obtained.

In some embodiments, the mounting bracket 7 may include a plurality of first brackets arranged in a row in the length direction of the first cavity 310, with adjacent first brackets abutting against each other, and the sum of the lengths of the plurality of first brackets is approximately equal to the length of the first cavity 310. That is, the mounting bracket 7 is a composite component consisting of a plurality of split components.

With this structure, the plurality of first brackets abut against each other to form the mounting bracket 7, and thus a proper number of first brackets can be selected according to the length of the first cavity 310 of the bottom plate 31 in various styles, which can improve the universality of the mounting bracket 7.

In some other embodiments, the mounting bracket 7 is a monomer component. That is, the mounting bracket 7 is an integrated component with a length approximately equal to the length of the first cavity 310.

With this structure, positioning of the restraining member 8 can be achieved by disposing one monomer component in the first cavity 310 of the bottom plate 31, which can further improve the assembly efficiency of the restraining member 8 in the bottom plate 31.

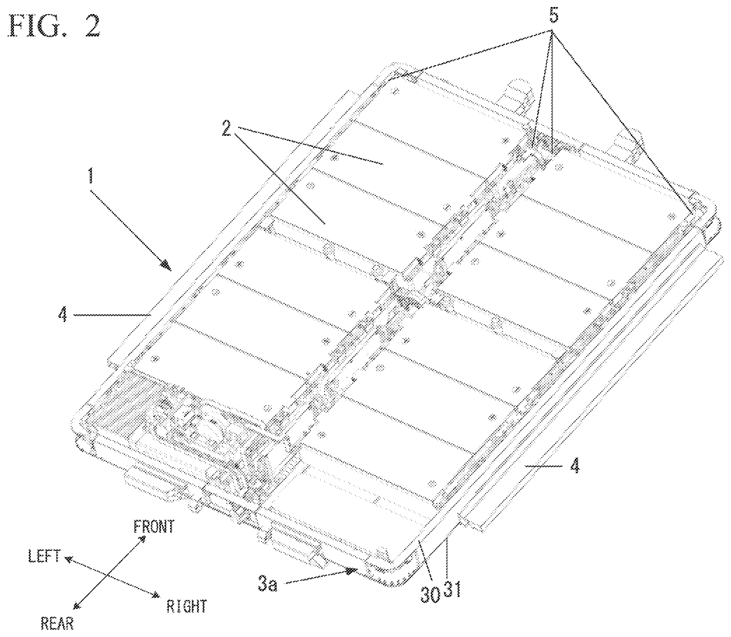

In some embodiments, with reference to FIG. 2, the battery modules 2 are plural, the plurality of the battery modules 2 are arranged in more than one row, and the length direction of the first cavity 310 is parallel to the arrangement direction of the battery modules 2 in more than one row.

As a result, because the mounting bracket 7 is inserted into the first cavity 310 in the arrangement direction of the battery modules 2 in each row, positioning of the restraining member 8 for fixing the battery modules 2 in each row can be achieved, and thus the restraining member 8 can be efficiently positioned, further improving the assembly efficiency of the restraining member 8 in the bottom plate 31.

In some embodiments, with reference to FIG. 2, the plurality of battery modules 2 are arranged in such a way that the long sides are parallel to each other and the short sides are on the same line, and the length direction of the first cavity 310 is parallel to the short side of the battery module 2.

With this structure, it is possible to reduce the number of first cavities 310 required and the number of mounting brackets 7 required.

In some other embodiments, the plurality of battery modules 2 can also be arranged in such a way that the short sides are parallel to each other and the long sides are on the same line, and the length direction of the first cavity 310 is parallel to the long side of the battery module 2.

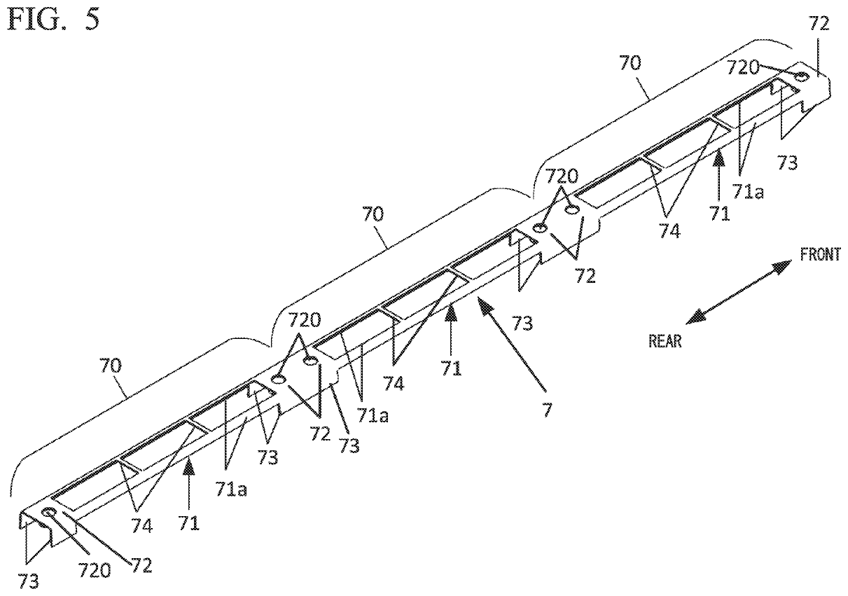

In some embodiments, with reference to FIG. 5 to FIG. 13, the mounting bracket 7 is of a hollow structure.

With this structure, it is possible to reduce the weight while ensuring the strength of the mounting bracket 7.

In some other embodiments, the mounting bracket 7 may be not of a hollow structure, but a plate-shaped structure.

With this structure, the strength of the mounting bracket 7 can be higher.

In some embodiments, with reference to FIG. 5 to FIG. 9, the side edge of the mounting bracket 7 in the length direction is provided with a supporting edge 73, and the supporting edge 73 extends toward the first mounting hole 314 or away from the first mounting hole 314.

Thus, in the case where the mounting bracket 7 is subjected to a torsional force, the supporting edge 73 can abut against the side wall of the first cavity 310 to prevent a situation where deformation is generated by the torsion of the mounting bracket 7.

In some embodiments, with reference to FIG. 5 to FIG. 9, the mounting bracket 7 is provided with a mounting portion 72, the restraining member 8 is mounted on the mounting portion 72, and the supporting edge 73 is disposed on the side edge of the mounting portion 72 on the mounting bracket 7. The side edge outside the mounting portion 72 on the mounting bracket 7 is not provided with a supporting edge 73.

With this structure, the supporting edge 73 is only disposed on the side edge of the mounting portion 72, which can prevent a situation where, due to the fact that the supporting edge 73 is disposed, the weight of the mounting bracket 7 increases excessively, while preventing the torsional deformation of the mounting bracket 7 by means of the supporting edge 73, and the stability of the mounting portion 72 can be improved by supporting the mounting portion 72 by means of the supporting edge 73.

In some other embodiments, the mounting bracket 7 may also be provided with the supporting edge 73 on the side edge in the length direction as a whole.

With this structure, the torsional deformation of the mounting bracket 7 can be more reliably prevented, and the stability of the mounting bracket 7 can be improved.

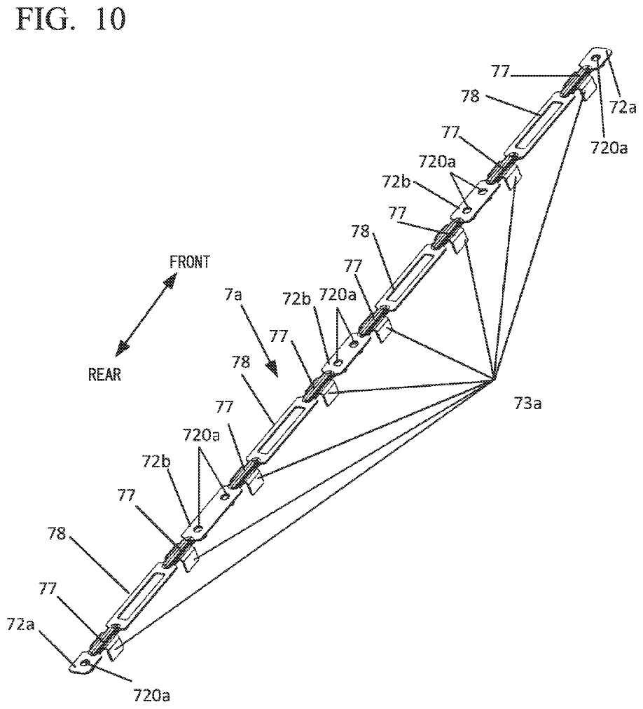

In some embodiments, with reference to FIG. 10 to FIG. 13, the mounting bracket 7a is provided with mounting portions 72a and 72b, the restraining member 8 is mounted on the mounting portions 72a and 72b, and the supporting edge 73a is disposed on adjacent side edges of the mounting portions 72a and 72b on the mounting bracket 7a. No supporting edge 73a is disposed on the side edges of the mounting portions 72a and 72b on the mounting bracket 7a.

With this structure, the supporting edge 73a is only disposed on the adjacent side edges of the mounting portions 72a and 72b, which can prevent a situation where, due to the fact that the supporting edge 73a is disposed, the weight of the mounting bracket 7a increases excessively, while preventing the torsional deformation of the mounting bracket 7a. Moreover, since no supporting edge 73a is disposed on the side edges of the mounting portions 72a and 72b, it is possible to avoid the case where, due to the supporting edge 73a, the operation of mounting the restraining member 8 on the mounting portions 72a and 72b is hindered.

In some embodiments, with reference to FIG. 5 to FIG. 9, the mounting bracket 7 is provided with a plurality of mounting portions 72, the restraining member 8 is mounted on the mounting portion 72, the mounting bracket 7 is provided with a hollow portion 71, and the hollow portion 71 is located between the adjacent mounting portions 72.

With this structure, it is possible to reduce the weight of the mounting bracket 7.

In some embodiments, with reference to FIG. 5 to FIG. 9, the mounting bracket 7 is provided with a reinforcing portion, and the reinforcing portion is located between the adjacent mounting portions 72.

With this structure, it is possible to ensure the strength of the mounting bracket 7.

In some embodiments, with reference to FIG. 5 to FIG. 9, the hollow portion 71 includes two edge portions 71a extending in the length direction of the mounting bracket 7 parallel to each other, and the reinforcing portion includes a reinforcing rib 74 connecting the two edge portions 71a.

With this structure, it is possible to reduce the weight while ensuring the strength of the mounting bracket 7.

In some other embodiments, the reinforcing rib 74 connecting the two edge portions 71a may be not disposed. With this structure, the weight of the mounting bracket 7 can be smaller.

In some embodiments, with reference to FIG. 10 to FIG. 13, the reinforcing portion includes a rib portion 77 extending in the length direction of the mounting bracket 7a, and in the length direction of the mounting bracket 7a, the hollow portion 78 and the mounting portions 72a and 72b are located on the opposite sides of the rib portion 77. The hollow portion 78 and the mounting portions 72a and 72b are not directly connected, but connected through the rib portion 77.

With this structure, the hollow portion 78 is disposed relatively far away from the mounting portions 72a and 72b to avoid any loss of strength in the vicinity of the mounting portions 72a and 72b, which reduces the weight while ensuring the strength of the mounting bracket 7a.

In some embodiments, with reference to FIG. 10 to FIG. 13, the rib portion 77 has a width smaller than that of the mounting portions 72a and 72b, supporting edges 73a are disposed on both sides of the rib portion 77 in the width direction of the mounting bracket 7a, and the sum of the width of the rib portion 77 and the width of the supporting edges 73a on both sides is greater than or equal to the width of the mounting portions 72a and 72b.

With this structure, it is possible to reduce the width of the mounting bracket 7a.

In some embodiments, the supporting edge 73 of the mounting bracket 7 include a pair of supporting edges 73 disposed obliquely, and the pair of supporting edges 73 extend, with the distance from each other gradually increasing, from the side edge in the length direction of the mounting bracket 7 toward the first mounting hole 314 or away from the first mounting hole 314. The ends of the pair of supporting edges 73 toward or away from the first mounting hole 314, that is, the parts with the maximum distance from each other, can abut against the side wall of the first cavity 310.

With this structure, the pair of supporting edges 73 are disposed obliquely, so that the mounting bracket 7 can form a roughly trapezoidal supporting structure, and the structure of the mounting bracket 7 can be more stable. Moreover, since only the parts with the maximum distance from each other, rather than the wholes, of the pair of supporting edges 73 abut against the side wall of the first cavity 310, the assembly operation of the mounting bracket 7 in the first cavity 310 can be performed easily.

In some embodiments, the first cavity 310 is provided with an opening at least at one end in the length direction, and the mounting bracket 7 is detachably inserted, from the opening, in the first cavity 310.

With this structure, it is possible to freely select the proper time for assembling the mounting bracket 7 in the first cavity 310 according to the actual requirements, which can improve the assembly flexibility.

In some embodiments, the material of the restraining member 8 is steel.

With this structure, since the strength of steel is high, it is possible to improve the fixing strength of the battery module 2.

In some embodiments, the restraining member 8 is a nut, and the fixing member 6 is a bolt.

With this structure, in the case where a nut made of steel is used as the restraining member 8, since the strength of steel is high, the strength can also be ensured even when the depth of a threaded hole of the nut is smaller, and thus it is possible to lower the requirement for the thread depth of the nut under the same strength requirement. Therefore, it is also possible to dispose a nut capable of ensuring the strength in the bottom plate 31 with a smaller thickness, and there is no need to change the thickness of the bottom plate 31 for meeting the requirement for the depth of a threaded hole.

In some other embodiments, the material of the restraining member 8 can also be a metal other than steel. The material of the restraining member 8 can be properly selected according to the thickness of the bottom plate 31 as long as the strength requirement can be met under the thickness of the bottom plate 31.

In some embodiments, for example, the restraining member 8 is welded to the mounting bracket 7. For example, the mounting bracket 7 is made of a metal, and the material of the mounting bracket 7 may be the same as or different from the material of the restraining member 8. When the materials thereof are the same, welding can be performed easily.

Some embodiments of the present disclosure will be further described in detail below with reference to FIGS. 1 to 14.

### Embodiment 1

Embodiment 1 is illustrated below with reference to FIG. 1 to FIG. 9. It is to be noted that the directions in the figures are marked only for facilitating illustration, rather than indicating that the device or element must have a specific orientation or be configured or operated with the specific orientation, and thus it cannot be understood as limiting the present disclosure.

The fixing device 5 provided in this embodiment is applied to a battery pack 1. The battery pack 1 is used for supplying power for a power motor of a vehicle to enable the power motor to drive wheels to rotate. With reference to FIG. 1 and FIG. 2, the battery pack 1 includes battery modules 2, a shell 3a, a top cover 3b and lifting lugs 4. The plurality of battery modules 2 are accommodated in the shell 3a. The shell 3a includes side plates 30 and a bottom plate 31. The side plate 30 rises upward from the edge portion of the bottom plate 31. The side plate 30 is provided with a cavity for vibration protection. The side plate 30 and the bottom plate 31 form a space for accommodating the plurality of battery modules 2. The top cover 3b is mounted on the shell 3a from a position above the shell, covering the plurality of battery modules 2 accommodated in the shell 3a. The lifting lugs 4 are mounted on each of the left and right sides of the shell 3a. The battery pack 1 is mounted at the bottom of the vehicle body of the vehicle by means of the lifting lugs 4.

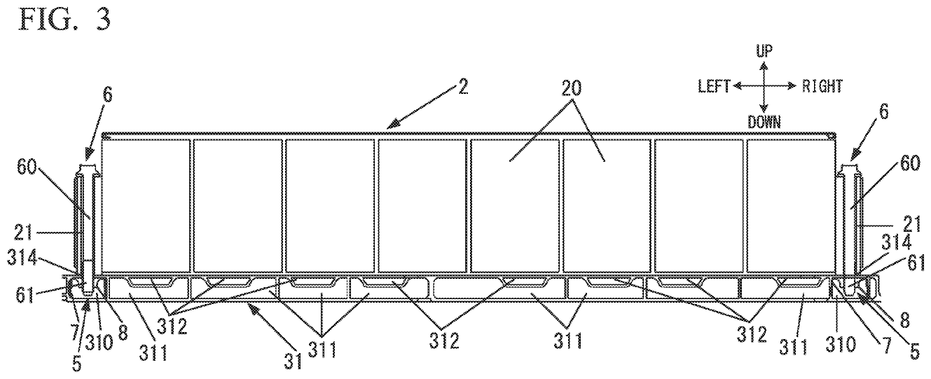

With reference to FIG. 3, each battery module 2 is formed by assembling a plurality of battery cells 20 in the left-right direction. With reference to FIG. 2, the plurality of battery modules 2 are arranged in more than one row within the shell 3a. Although FIG. 2 shows an example of two rows of left and right battery modules 2 arranged in the front-rear direction, the present disclosure is not limited to this. The number of rows of the battery modules 2 and the number of the battery modules 2 in each row can be suitably set. For example, the battery modules 2 in each row are arranged in such a way that the long sides of the battery modules 2 are parallel to each other and the short sides of the battery modules are on the same line. In FIG. 2, the long side of each battery module 2 extends in the left-right direction, the short side of each battery module extends in the front-rear direction, and the battery modules 2 in each row are arranged in the front-rear direction. The battery module 2 is fixed to the bottom plate 31 of the shell 3a by the fixing device 5. In FIG. 2, the fixing device 5 is disposed at four positions in total, with two fixing devices disposed at both ends in the left-right direction of the battery pack 1 and two fixing devices disposed in the central part to fix two rows of battery modules 2. However, the number and positions of the fixing device 5 are not limited to this, and the fixing device can be designed suitably according to the arrangement mode of the plurality of battery modules 2.

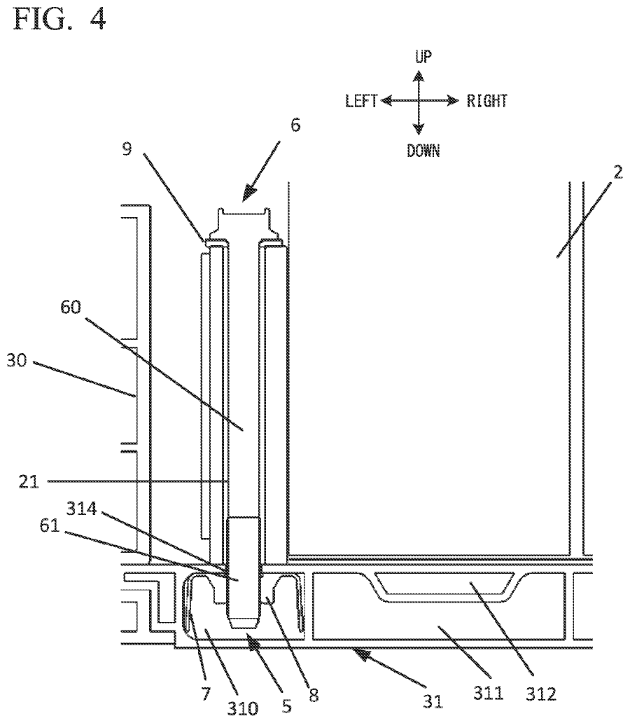

With reference to FIG. 3 and FIG. 4, the fixing device 5 includes a fixing member 6, a mounting bracket 7 and a restraining member 8. In this embodiment, the fixing member 6 is a bolt, and the restraining member 8 is a nut. The fixing member 6 includes a rod portion 60 and a threaded portion 61. The mounting bracket 7 is disposed in the first cavity 310 of the bottom plate 31. For example, the restraining member 8 is welded to the mounting bracket 7, such as the lower surface of the mounting bracket 7. The restraining member 8 is made of a metal, e.g., steel. The mounting bracket 7 is made of a metal, but from the viewpoint of ease of welding, the mounting bracket can be made of, for example, the same steel as the restraining member 8, but the present disclosure is not limited to this, and the mounting bracket can also be made of other types of metals.

In the case of the nut made of steel as the restraining member 8, the depth of a threaded hole need only be, for example, 7 to 8 mm, to ensure strength. In the case of a threaded hole made of aluminum, a minimum of 25 mm is required to ensure the same strength. If the bottom plate 31 is made of aluminum and the thickness thereof is, for example, about 20 mm, the requirement for the depth of a threaded hole made of aluminum cannot be met. By making the material of the nut as the restraining member 8 steel, the requirement for the thread depth of the nut can be lowered, and the strength can also be reliably ensured even with a bottom plate 31 of a smaller thickness, without having to thicken the bottom plate 31 by changing the style of the bottom plate 31 of the battery pack.

With reference to FIG. 3 and FIG. 4, the bottom plate 31 has first cavities 310, and the mounting bracket 7 provided with the restraining member 8 is disposed in the first cavity 310. The first cavities 310 extend in the arrangement direction of the battery modules 2 arranged in more than one row. The length direction of the first cavities 310 is parallel to the arrangement direction. With reference to FIG. 2 at the same time, the length direction of the first cavities 310 is parallel to the short side direction of the battery module 2. The first cavities 310 are plural. In addition, the bottom plate 31 is further provided with second cavities 311 and third cavities 312 in addition to the first cavities 310. The second cavities 311 and the third cavities 312 are both plural. The second cavities 311 are used for mitigating the influence of the external environment on the battery module 2, such as avoiding vibration, impact force, and transfer of heat in external environments to the battery module 2. The third cavities 312 are used as a flow path of coolant for cooling the battery module 2.

With reference to FIG. 3 and FIG. 4, the bottom plate 31 is provided with a first mounting hole 314 penetrating through the cavity wall of the first cavity 310. The first mounting hole 314 penetrates through the upper cavity wall of the first cavity 310. The battery module 2 is provided with a second mounting hole 21 at each of both ends in the length direction. The second mounting hole 21 penetrates through the end of the battery module 2 in the up-down direction. The rod portion 60 of the fixing member 6 is inserted into the second mounting hole 21 of the battery module 2, and the threaded portion 61 of the fixing member 6 passes through the first mounting hole 314 of the bottom plate 31 to be tightened to the restraining member 8 mounted on the mounting bracket 7 in the first cavity 310, thereby fixing the battery module 2 to the bottom plate 31. In addition, the fixing member 6 is sleeved with a gasket 9 and the gasket 9 is clamped between the head of the fixing member 6 and the battery module 2. The first mounting hole 314 and the second mounting hole 21 can be, for example, both round holes, or in other shapes, as long as they can be used in cooperation with the fixing member 6, etc. to fix the battery module 2 to the bottom plate 31.

The first cavity 310 is provided with an opening at least at one end in the length direction. In FIG. 3, the first cavity 310 has the opening at the front end and/or the rear end with the length direction the same as the front-rear direction. The mounting bracket 7 is detachably inserted, from the opening of the first cavity 310, into the first cavity 310. Thus, the proper time for assembling the mounting bracket 7 in the first cavity 310 can be freely selected according to actual needs, which can enhance the flexibility of assembling the restraining member 8.

The mounting bracket 7 extends in the length direction of the first cavity 310 to be configured, and has a length approximately equal to that of the first cavity 310. Thus, when the restraining member 8 is assembled in the first cavity 310 using the mounting bracket 7, by aligning the mounting bracket 7 and the first cavity 310 with the length appropriately equal, positioning of the restraining member 8 in the length direction (i.e., the front-rear direction) of the first cavity 310 can be achieved, which can simplify the positioning process of the restraining member 8 and improve the assembly efficiency of the restraining member 8 in the first cavity 310. In addition, the positioning of the restraining member 8 can be easily achieved without disposing a special positioning structure, and the technical effects of a simple structure and a low manufacturing cost can be obtained.

In addition, the width of the mounting bracket 7 can be approximately equal to the width of the first cavity 310 to achieve the positioning of the restraining member 8 in the left-right direction. However, the present disclosure is not limited to this, and it is also possible to dispose a special positioning portion on the mounting bracket 7 and the bottom plate 31 to achieve positioning of the restraining member 8 in the left-right direction.

The mounting bracket 7 is a monomer component with the same length as the first cavity 310. That is, the mounting bracket 7 is an integrated component. The mounting bracket 7 is formed integrally, for example, by punching forming. Thus, the positioning of the restraining member 8 can be achieved by disposing one monomer component in one first cavity 310, which can further improve the assembly efficiency of the restraining member 8 in the first cavity 310.

The mounting bracket 7 is of a hollow structure. Thus, it is possible to reduce the weight while ensuring the strength. More specific content about the hollow structure will be described below.

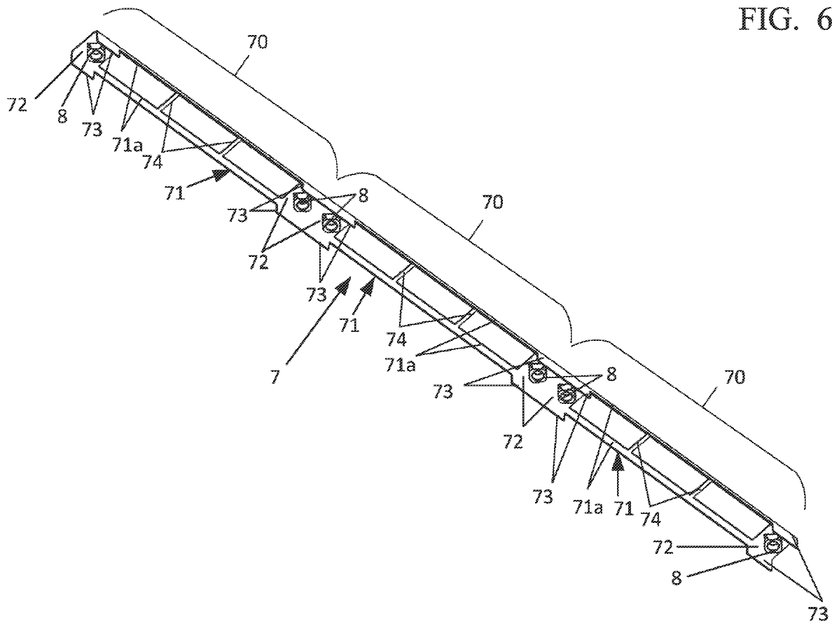

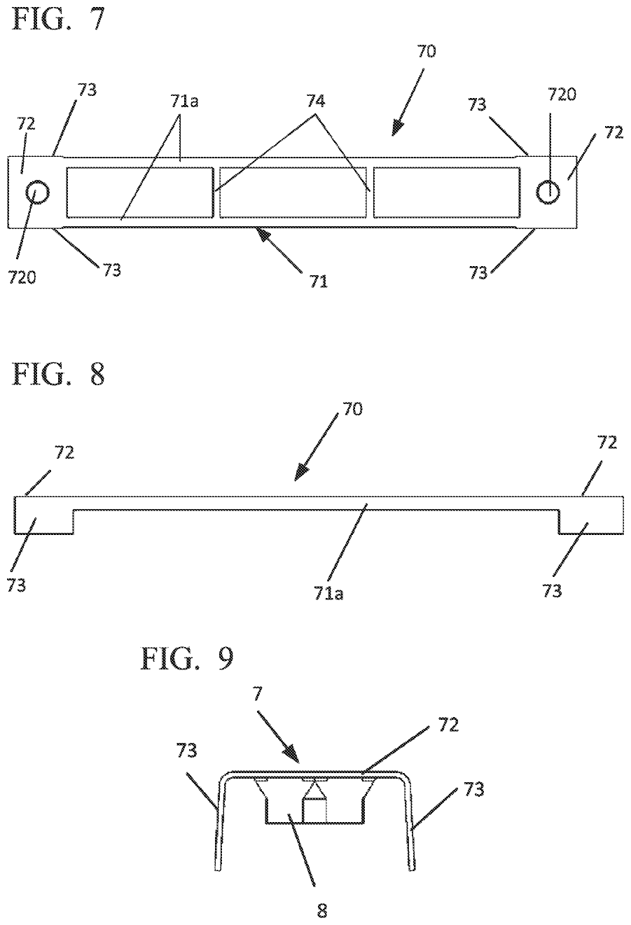

With reference to FIG. 5 and FIG. 6, the mounting bracket 7 includes more than one bracket portion 70. The more than one bracket portion 70 is arranged on a straight line. Each bracket portion 70 corresponds to one battery module 2. FIG. 5 and FIG. 6 show an example where the mounting bracket 7 includes three bracket portions 70, but it is only an example, and at least one bracket portion 70 is sufficient. In fact, the number of the bracket portions 70 may be the same as the number of the battery modules 2 arranged in each row of battery modules 2. For example, in the example of FIG. 2, seven battery modules 2 can be arranged in each row, and then the mounting bracket 7 can include seven bracket portions. In addition, since the structures of the plurality of bracket portions 70 are identical to each other, FIG. 7 and FIG. 8 show a top view and a side view of only one bracket portion 70, respectively.

With reference to FIG. 5 to FIG. 8, the bracket portion 70 includes a hollow portion 71, two front and rear mounting portions 72, and a plurality of supporting edges 73. The hollow portion 71 includes two left and right edge portions 71a, and the two left and right edge portions 71a are spaced apart to extend parallel to each other in the front-rear directions (length direction of the mounting bracket 7). The two front and rear mounting portions 72 are connected between the two edge portions 71a. Thus, the weight can be reduced by the interval between the two edge portions 71a of the hollow portion 71, while the strength is ensured by the mounting portion 72. The number of the mounting portions 72 is not limited to two, and corresponds to the number of the second mounting holes 21 formed in both ends in the long side direction of the battery module 2, for example, one or more than three.

With reference to FIG. 5 and FIG. 7, the mounting portion 72 has a through hole 720 in the central part, and the restraining member 8 is welded to the lower surface of the mounting portion 72 in such a way that the threaded hole thereof is aligned with the through hole 720.

With reference to FIG. 3, FIG. 6, and FIG. 8, a plurality of supporting edges 73 extend downward from the left and right side edges of the mounting portion 72, i.e., away from the first mounting hole 314. The supporting edge 73 extends towards the side where the restraining member 8 is mounted. Thus, when the restraining member 8 is subjected to a large torsional force when the fixing member 6 is tightened to the restraining member 8, the supporting edge 73 can abut against the side wall of the first cavity 310 to restrain the torsional deformation of the mounting bracket 7. The plurality of supporting edges 73 are disposed in pairs on the left and right sides of the mounting portion 72.

With reference to FIG. 9, the paired supporting edges 73 extend obliquely downward from the left and right side edges of mounting portion 72. The distance between the paired supporting edges 73 in the left-right direction gradually increases as they move from the upper portion to the lower portion. That is, the paired supporting edges 73 extend, with the distance from each other gradually increasing, away from the first mounting hole 314r. Since the paired supporting edges 73 are disposed obliquely in this way, the mounting bracket 7 can form a substantially trapezoidal supporting structure, and the structure of the mounting bracket 7 can be made more stable.

The supporting edge 73 extends toward the side of the mounting bracket 7 where the restraining member 8 is mounted, so that the restraining member 8 is located on the same side as the supporting edge, which can minimize the space occupied by the mounting bracket 7.

The ends of the paired supporting edges 73 on the side where the restraining member 8 is mounted, i.e., the lower ends, can abut against the side wall of the first cavity 310. The distance between the lower ends of the paired supporting edges 73 is, for example, approximately equal to the width of the first cavity 310 in the left-right direction. Thus, the torsional deformation of the mounting bracket 7 when subjected to the torsional force can be restrained.

The bracket portion 70 further includes two reinforcing ribs 74. The two reinforcing ribs 74 extend between the two mounting portions 72 in the width direction (left-right direction) of the mounting bracket 7, and are disposed apart in the length direction of the mounting bracket 7 to connect the two edge portions 71a of the hollow portion 71, thereby avoiding the case where the weight of the mounting bracket 7 is excessive while achieving reinforcement by the reinforcing rib 74. The number of the reinforcing ribs 74 is not limited to two, but can also be one or more than three.

With reference to FIG. 5, the mounting portions 72 on adjacent sides of two adjacent bracket portions 70 in the plurality of bracket portions 70 are connected into a whole. The two mounting portions 72 connected into a whole are used for fixing adjacent ends of two adjacent battery modules 2 in the arrangement direction (the front-rear direction in FIG. 2) of more than one row of battery modules 2. From the viewpoint of the whole mounting bracket 7 including the plurality of bracket portions 70, it is also possible to consider the two mounting portions 72 connected into a whole as one mounting portion, so that the hollow portion 71 and the reinforcing rib 74 are disposed between two adjacent mounting portions of the mounting bracket 7. Also, from the viewpoint of the whole mounting bracket 7, the supporting edge 73 is disposed on the side edge of the mounting bracket 7 in the length direction to extend away from the first mounting hole 314.

In addition, the cross section of the first cavity 310 is, for example, substantially quadrilateral. Rounded corners can be formed by rounding off at least one corner in the quadrilateral cross section. For example, a pair of corners disposed in the thickness direction and/or length direction of the bottom plate 31 can be formed as rounded corners. With reference to FIG. 4, a pair of corners at the left end of the first cavity 310 are formed as rounded corners. When the mounting bracket 7 is inserted into the first cavity 310, the pair of rounded corners can serve to guide the mounting bracket 7. Moreover, since the corner at the lower end forms a rounded corner, the height of the bottom wall of the bottom plate 31 in the up-down direction of the rounded corner is greater than that of other parts, and the height of the supporting edge 73 in the thickness direction of the bottom plate 31, i.e., in the up-down direction, does not have to be formed exactly the same as that of the first cavity 310, and the supporting edge 73 can also be supported by the rounded corner. Thus, the height of the mounting bracket 7 can be reduced and the case where the weight is increased excessively due to the fact that the supporting edge 73 is disposed is avoided while the torsional deformation of the mounting bracket 7 is prevented. In addition, it is possible to flexibly respond to the size deviation of the supporting edge 72 in the up-down direction to more stably support the mounting bracket 7.

In summary, this embodiment provides a fixing device 5 for battery modules 2. The battery module 2 is fixed to the bottom plate 31 having the first cavity 310 by the fixing device 5, and the bottom plate 31 is provided with the first mounting hole 314 penetrating through the cavity wall of the first cavity 310; the fixing device 5 includes the mounting bracket 7, the nut made of steel as the restraining member 8 and the bolt as the fixing member 6, the mounting bracket 7 extending in the length direction of the first cavity 310 to be disposed in the first cavity 310, and the mounting bracket 7 being the monomer component, with the length being approximately equal to that of the first cavity 310; the nut made of steel as the restraining member 8 being mounted on the mounting bracket 7; and the bolt as the fixing member 6 penetrating through the first mounting hole 314 to be fixed to the restraining member 8 so as to fix the battery module 2 to the bottom plate 31. The plurality of the battery modules 2 are arranged in more than one row in such a way that the long sides are parallel to each other and the short sides are on the same straight line and the length direction of the first cavity 310 is parallel to the short side of the battery module 2. Thus, the positioning process of the restraining member 8 can be simplified, and the assembly efficiency of the restraining member 8 in the bottom plate is improved. The nut made of steel is used as the restraining member 8, which can lower the requirement for the thread depth of the nut, and a nut capable of ensuring the strength can also be disposed in the bottom plate 31 with a smaller thickness.

The mounting bracket 7 is of a hollow structure, the supporting edges 73 are disposed on the side edges of the mounting bracket 7 in the length direction, and the supporting edges 73 extend away from the first mounting hole 314. The mounting bracket 7 is provided with a plurality of mounting portions 72, the restraining member 8 is mounted on the mounting portions 72, and the supporting edges 73 are disposed on the side edges of the mounting portions 72 on the mounting bracket 7. The hollow portion 71 and the reinforcing rib 74 are disposed between two adjacent mounting portions 72. The hollow portion 71 includes two edge portions 71a extending in the length direction of the mounting bracket 7 parallel to each other, and the two edge portions 73 are connected by the reinforcing rib 74. Thus, it is possible to reduce the weight while ensuring the strength. The mounting bracket 7 is provided with a pair of oblique supporting edges 73, and the pair of oblique supporting edges 73 extend, with the distance from each other gradually increasing, from the side edge of the mounting portion 72 on the mounting bracket 7 away from the first mounting hole 314. Thus, it is possible to restrain the torsional deformation of the mounting bracket 7.

In addition, although in this embodiment, the mounting bracket 7 is a monomer component including the plurality of bracket portions 70, the mounting bracket 7 may also include a plurality of split brackets. For example, the mounting bracket 7 can be divided into a plurality of monomer components with the unit of the bracket portion 70, and the plurality of monomer components can be combined to form the mounting bracket 7. For example, one or more bracket portions 70 can be used as a first bracket, and the plurality of first brackets can abut against each other to form the mounting bracket 7. In this case, it is possible to select a corresponding number of first brackets to abut against each other to form the mounting bracket 7 according to the style of the battery pack 1, and the universality of the mounting bracket 7 can be improved.

Although in this embodiment, the plurality of bracket portions 70 included in the mounting bracket 7 are of the same structure, the present prevention is not limited to this. It is also possible to make the number and size of the structural portions such as the hollow portion 71, the mounting portion 72, the supporting edge 73, and the reinforcing rib 74 of the plurality of bracket portions 70 different from each other. For example, with reference to FIG. 5, the size of the mounting portions 72 at both ends of the mounting bracket 7 can be different from the size of the middle mounting portion 72, and the size of the middle mounting portion 72 can be suitably set according to the interval between two adjacent battery modules 2, etc.

Although in this embodiment, the battery modules 2 in each row are arranged in such a way that the long sides are parallel to each other and the short sides are on the same line, the battery modules can also be arranged in other ways. For example, the battery modules 2 in each row may also be arranged in such a way that the short sides are parallel to each other and the long sides are on the same straight line.

Although in this embodiment, the supporting edge 73 is only disposed on the side edge of the mounting portion 72, it is also possible to dispose the supporting edge 73 on the whole side edge of the mounting bracket 7. Although in this embodiment, the restraining member 8 is welded to the lower surface of the mounting bracket 7, it is also possible to weld the restraining member 8 to the upper surface of the mounting bracket 7.

Although in this embodiment, the supporting edge 73 of the mounting bracket 7 extends away from the first mounting hole 314, it is also possible to make the supporting edge 73 extend toward the first mounting hole 314. In this case, it is possible to make the supporting edge 73 abut against the upper cavity wall or side cavity wall of the first cavity 310. It is also possible to form the two corners on the lower side of the quadrilateral cross section of the first cavity 310 into rounded-off corners to support the lower surface of the mounting bracket 7.

Although in this embodiment, the mounting bracket 7 has the supporting edge 73 and the reinforcing rib 74, the mounting bracket 7 may also not have the supporting edge 73 and/or the reinforcing rib 74.

Although in this embodiment, the first mounting hole 314 penetrates through only the upper cavity wall of the first cavity 310, it is also possible to make the first mounting hole 314 penetrate through the upper cavity wall and the lower cavity wall of the first cavity 310 at the same time. However, considering that there is a concern of water penetrating into the battery pack 1 from the first mounting hole 314 if the first mounting hole penetrates through the lower cavity wall at the same time, it is preferred that the first mounting hole only penetrate through the upper cavity wall of the first cavity 310 from the viewpoint of avoiding the case where water enters the battery pack 1.

Although in this embodiment, the fixing member 6 is a bolt, the restraining member 8 is a nut, and the threaded-fit fixing method is used to fix the battery module 2, other fixing methods can also be used. For example, it is possible to use an inserting and clamping fixing method in which the fixing member is a pin-like member, the restraining member has an inserting port receiving the end of the fixing member, and the end of the fixing member is inserted into the inserting port so that the restraining member is clamped to the fixing member and cannot be pulled out.

### Embodiment 2

Embodiment 2 is illustrated below. Embodiment 2 differs from Embodiment 1 in that a mounting bracket 7a is disposed in the first cavity 310. The structure of the mounting bracket 7a is different from that of the above-mentioned mounting bracket 7, and except that, Embodiment 2 is the same as Embodiment 1. For the same content as in Embodiment 1, the same reference numerals are marked and repeated descriptions are omitted.

The mounting bracket 7a in Embodiment 2 will be described in detail below with reference to FIG. 10 to FIG. 13.

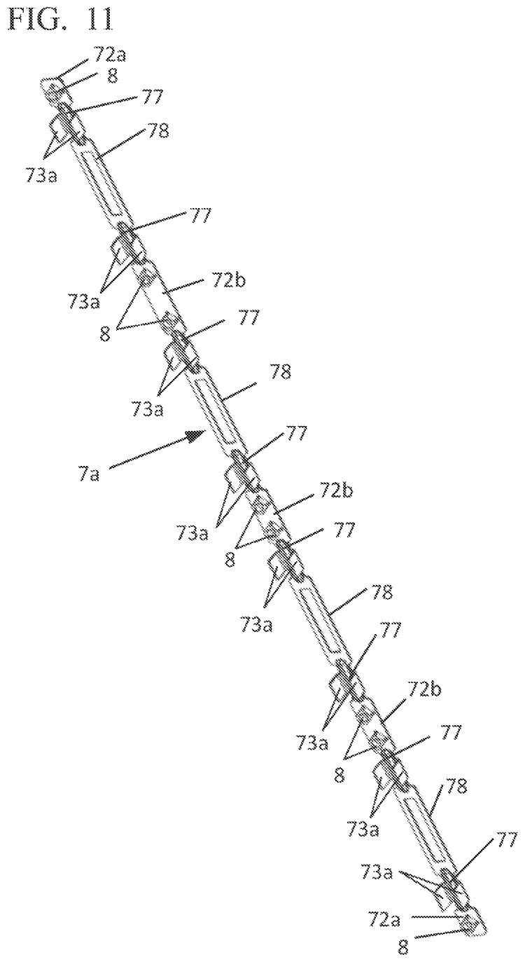

The mounting bracket 7a is made of a metal, for example, steel. The mounting bracket 7a is a monomer component, and integrally formed by punching, but the mounting bracket 7a is not limited to this and can also be formed in other methods. The mounting bracket 7a has a length approximately equal to that of the first cavity 310. With reference to FIG. 10 and FIG. 11, the mounting bracket 7a includes two mounting portions 72a located at both ends in the length direction, a plurality of mounting portions 72b located in the middle, a plurality of rib portions 77, a plurality of hollow portions 78, and a plurality of supporting edges 73a. The rib portion 77 and the hollow portion 78 are located between the mounting portion 72a and the mounting portion 72b or between two mounting portions 72b in the length direction of the mounting bracket 7a. In the length direction of the mounting bracket 7a, one side of the rib portion 77 is provided with the hollow portion 78 and the other side of the rib portion is provided with the mounting portion 72a or the mounting portion 72b. That is, the hollow portion 78 and the mounting portion 72a or the mounting portion 72b are disposed on the opposite sides of the rib portion 77 in the length direction of the mounting bracket 7a.

Specifically, the mounting portion 72a, the mounting portion 72b, the plurality of rib portions 77, and the plurality of hollow portions 78 are connected in sequence in the order of the mounting portion 72a, the rib portion 77, the hollow portion 78, the rib portion 77, the mounting portion 72b, the rib portion 77, the hollow portion 78, the rib portion 77, the mounting portion 72b . . . the mounting portion 72b, the rib portion 77, the hollow portion 78, the rib portion 77, and the mounting portion 72a in the length direction of the mounting bracket 7a

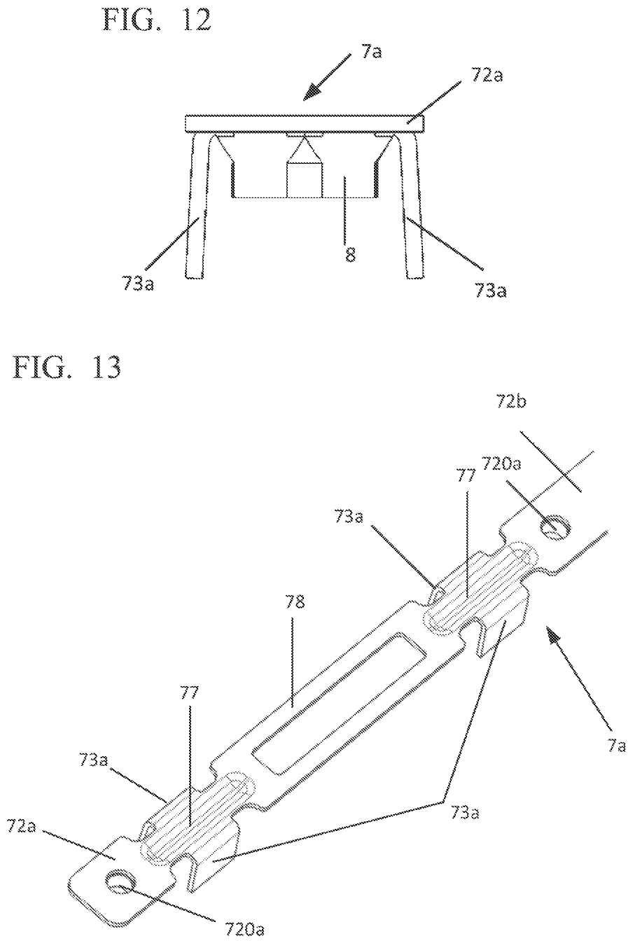

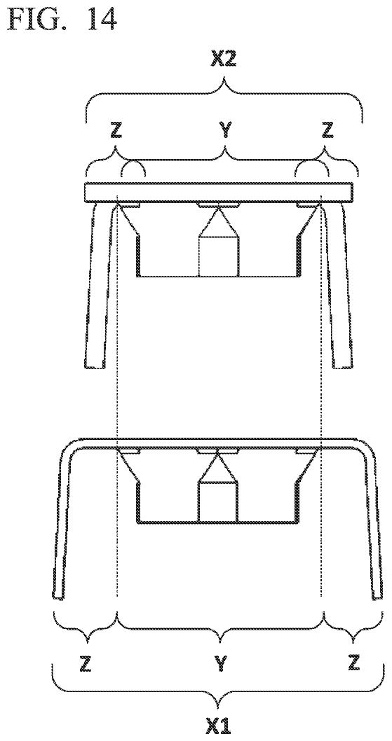

With reference to FIG. 12, the restraining member 8 is mounted on the lower surface of the mounting bracket 7a. Further with reference to FIG. 13, the mounting portion 72a has a through hole 720a in the central part, and one restraining member 8 is welded to the lower surface of the mounting portion 72a with a threaded hole thereof aligned with the through hole 720a. Further with reference to FIG. 10, the mounting portion 72b has two through holes 720a arranged front and back, and two restraining member members 8 are welded to the lower surface of the mounting portion 72b, with threaded holes thereof each aligned with two through holes 720a.

The rib portion 77 is in the shape of a long strip and extends in the length direction of the mounting bracket 7a to be disposed and is a pressed rib formed by punching. The rib portion 77 is in the shape of a curved plate with a concave upper surface and a convex lower surface. The rib portion 77 may also be in the shape of a curved plate with a convex upper surface and a concave lower surface. The rib portion 77 is not limited to being formed by punching, and may also be formed through another method, for example, the rib portion may be in the shape of a flat plate with a thickness greater than that of the rest of the mounting bracket 7a except for the rib portion 77. The mounting portion 72a and the mounting portion 72b are each connected to the rib portion 77 at least at one end, thereby enabling the mounting portion 72a and the mounting portion 72b to be reinforced by the rib portion 77. The rib portion 77 has a width less than that of the mounting portion 72a, the mounting portion 72b, and the plurality of hollow portions 78. The width here refers to the size in the width direction (left-right direction) of the mounting bracket 7a. Thus, it is possible to reduce the weight while ensuring strength.

The hollow portion 78 is connected between two adjacent rib portions 77. The outer periphery of the hollow portion 78 is, for example, in a substantially rectangular shape, with the long side extending in the length direction (front-rear direction in FIG. 10) of the mounting bracket 7a. The hollow portion 78 has a long hole extending in the length direction of the mounting bracket 7a, and the long hole is, for example, in a substantially rectangular shape. Thus, the hollow portion 78 and the mounting portions 72a and 72b are not directly connected, but connected by the rib portion 77, so that a loss of strength in the vicinity of the mounting portions 72a and 72b can be avoided, and it is possible to reduce the weight while ensuring strength.

The plurality of supporting edges 73a are disposed on the side edges of the mounting bracket 7a in the length direction. Specifically, the plurality of supporting edges 73a are disposed on adjacent side edges of the mounting portions 72a, 72b on the mounting bracket 7a. More specifically, the supporting edges 73a are disposed on both sides of the rib portion 77 in the width direction of the mounting bracket 7a, and the sum of the width of the rib portion 77 (size in the width direction of the mounting bracket 7a) and the width of the supporting edges 73a on both sides (size in the width direction of the mounting bracket 7a) is greater than or equal to the width of the mounting portions 72a, 72b.

The plurality of supporting edges 73a extend downward from the left and right side edges of the central part of the rib portion 77 in the length direction, i.e., away from the first mounting hole 314. The supporting edge 73a extends toward the side of the mounting bracket 7a where the restraining member 8 is mounted. The length of the supporting edge 73a in the front-rear direction is less than that of the rib portion 77 in the front-rear direction. The lower end of the supporting edge 73a is capable of abutting against the side wall of the first cavity 310. The plurality of supporting edges 73a are disposed in pairs on the left and right. One pair of supporting edges 73a extend, with the distance from each other gradually increasing, from the side edge at the rib portion 77 to the side of the mounting bracket 7a where the restraining member 8 is mounted. Thus, it is possible to restrain the torsional deformation of the mounting bracket 7a by the supporting edge 73a abutting against the side wall of the first cavity 310. Moreover, since the supporting edge 73a is not disposed on the side edges of the mounting portions 72a and 72b, it is possible to avoid the case where the operation of mounting the restraining member 8 on the mounting portions 72a and 72b is hindered by the supporting edge 73a.

With the mounting bracket 7a of Embodiment 2, it is possible to reduce the width of the mounting bracket by disposing the supporting edges on both sides of the rib portion, since the width of the rib portion is smaller than the width of the mounting portion, as shown in FIG. 14, compared with the supporting edge disposed on both sides of the mounting portion. The minimum manufacturing width of the mounting portion is assumed to be Y, and the minimum manufacturing width of the supporting edge is assumed to be Z. When the supporting edges are disposed on both sides of the mounting portion, the width of the mounting bracket X1=Y+2Z as shown in the lower figure in FIG. 14. In contrast, when the supporting edges are disposed on both sides of the rib portion, because the width of the rib portion is smaller than the width of the mounting portion, the supporting edge is shifted to the inner side relative to the outer edge of the mounting portion as shown in the upper figure in FIG. 14, and therefore the width of the mounting bracket X2<Y+2Z. That is, the width X2 of the mounting bracket when the supporting edge is disposed on the rib portion is smaller than the width X1 of the mounting bracket when the supporting edge is disposed on the mounting portion. It is possible to insert the mounting bracket 7a of Embodiment 2 into the first cavity 310 even with a smaller width because it is possible to reduce the width of the mounting bracket 7a.

In summary, this embodiment provides a fixing device 5 for battery modules 2. The battery module 2 is fixed to the bottom plate 31 having the first cavity 310 by the fixing device 5, and the bottom plate 31 is provided with the first mounting hole 314 penetrating through the cavity wall of the first cavity 310; the fixing device 5 includes the mounting bracket 7, the nut made of steel as the restraining member 8 and the bolt as the fixing member 6, the mounting bracket 7 extending in the length direction of the first cavity 310 to be disposed in the first cavity 310, and the mounting bracket 7 being the monomer component, with the length being approximately equal to that of the first cavity 310; the nut made of steel as the restraining member 8 being mounted on the mounting bracket 7a; and the bolt as the fixing member 6 penetrating through the first mounting hole 314 to be fixed to the restraining member 8 so as to fix the battery module 2 to the bottom plate 31. The plurality of the battery modules 2 are arranged in such a way that the long sides are parallel to each other, the short sides are on the same straight line, and the length direction of the first cavity 310 is parallel to the short side of the battery module 2. Thus, the positioning process of the restraining member 8 can be simplified, and the assembly efficiency of the restraining member 8 in the bottom plate 31 is improved. The nut made of steel is used as the restraining member 8, which can lower the requirement for the thread depth of the nut, and a nut capable of ensuring the strength can also be disposed in the bottom plate 31 with a smaller thickness.

The mounting bracket 7a is provided with a plurality of mounting portions 72a and 72b, the restraining member 8 is mounted on the mounting portions 72a and 72b, the hollow portion 78 and the rib portion 77 are disposed between adjacent mounting portions 72a and 72b, and the hollow portion 78 and the mounting portions 72a and 72b are located on the opposite sides of the rib portion 77 in the length direction of the mounting bracket 7a. Thus, it is possible to reduce the weight while ensuring the strength. The rib portion 77 has a width smaller than that of the mounting portions 72a and 72b, supporting edges 73a are disposed on the both sides of the rib portion 77 in the width direction of the mounting bracket 7a, and the sum of the width of the rib portion 77 and the width of the supporting edge 73a on both sides is greater than or equal to the width of the mounting portions 72a and 72b. Thus, it is possible to restrain the torsional deformation of the mounting bracket 7a and reduce the width of the mounting bracket 7a, and it is also possible to avoid the case where the operation of mounting the restraining member 8 on the mounting portions 72a and 72b is hindered by the supporting edge 73a. The mounting bracket 7a is provided with a pair of oblique supporting edges 73a, the pair of oblique supporting edges 73a extend, with the distance from each other gradually increasing, from the side edge of the rib portion 77 away from the first mounting hole 314. Thus, the structure of the mounting bracket 7a is made more stable and the assembly operation of the mounting bracket 7a in the first cavity 310 can be easily carried out.

An embodiment of the present disclosure further provides a battery pack 1, including battery modules and a shell 3a, the shell 3a including a bottom plate 31 having first cavities 310, and the battery module 2 being fixed to the bottom plate 31 by means of the fixing device 5 according to any embodiment described above.

Thus, when the battery module 2 is fixed to the bottom plate 31 of the battery pack 1, the positioning process of a restraining member 8 can be simplified, and the assembly efficiency of the restraining member 8 in the bottom plate 31 is improved. In addition, the positioning of the restraining member 8 can be easily achieved without disposing a special positioning structure, and the technical effects of a simple structure and a low manufacturing cost can be obtained.

An embodiment of the present disclosure further provides a vehicle having a battery pack 1.

Thus, when battery modules 2 are fixed to a bottom plate 31 of the battery pack 1, the positioning process of a restraining member 8 can be simplified, and the assembly efficiency of the restraining member 8 in the bottom plate 31 is improved. In addition, the positioning of the restraining member 8 can be easily achieved without disposing a special positioning structure, and the technical effects of a simple structure and a low manufacturing cost can be obtained.

The technical features in the foregoing embodiments may be randomly combined. For concise description, not all possible combinations of the technical features in the foregoing embodiments are described. However, provided that combinations of the technical features do not conflict with each other, the combinations of the technical features are considered as falling within the scope described in this specification.

The foregoing embodiments only describe several implementations of the present disclosure, and the description is specific and detailed, but cannot therefore be understood as a limitation to the patent scope of the present disclosure. It should be noted that a person of ordinary skill in the art may further make several variations and improvements without departing from the concept of the present disclosure, and these variations and improvements all fall within the protection scope of the present disclosure. Therefore, the protection scope of the patent of the present disclosure shall be subject to the appended claims.

What is claimed is:

1. A fixing device for battery modules, wherein a battery module is fixed to a bottom plate having a first cavity by the fixing device, and the bottom plate is provided with a first mounting hole penetrating through the cavity wall of the first cavity; the fixing device comprises:
a mounting bracket extending in the length direction of the first cavity to be arranged in the first cavity, the length of the mounting bracket being approximately equal to that of the first cavity;
a restraining member mounted on the mounting bracket; and
a fixing member penetrating through the first mounting hole to be fixed to the restraining member so as to fix the battery module to the bottom plate.

2. The fixing device according to claim 1, wherein the mounting bracket comprises a plurality of first brackets arranged in a row in the length direction of the first cavity, with adjacent first brackets abutting against each other, and the sum of the lengths of the plurality of first brackets is approximately equal to the length of the first cavity.

3. The fixing device according to claim 1, wherein the mounting bracket is a monomer component.

4. The fixing device according to claim 1, wherein the battery modules are plural, the plurality of battery modules are arranged in more than one row, and the length direction of the first cavity is parallel to the arrangement direction of the battery modules in more than one row.

5. The fixing device according to claim 4, wherein the plurality of battery modules are arranged in such a way that the long sides are parallel to each other and the short sides are on the same line, and the length direction of the first cavity is parallel to the short side of the battery module.

6. The fixing device according to claim 1, wherein the mounting bracket is of a hollow structure.

7. The fixing device according to claim 1, wherein the side edges of the mounting brackets in the length direction are provided with supporting edges, and the supporting edges extend toward the first mounting hole or away from the first mounting hole.

8. The fixing device according to claim 7, wherein the mounting bracket is provided with a mounting portion, the restraining member is mounted on the mounting portion, and the supporting edge is disposed on the side edge of the mounting portion on the mounting bracket.

9. The fixing device according to claim 7, wherein the mounting bracket is provided with mounting portions, the restraining member is mounted on the mounting portions, and the supporting edge is disposed on adjacent side edges of the mounting portions on the mounting bracket.

10. The fixing device according to claim 7, wherein the mounting bracket is provided with a plurality of mounting portions, the restraining member is mounted on the mounting portions, the mounting bracket is provided with hollow portions, and the hollow portions are located between the adjacent mounting portions.

11. The fixing device according to claim 10, wherein
the mounting bracket is provided with reinforcing portions, and the reinforcing portions are located between the adjacent mounting portions.

12. The fixing device according to claim 11, wherein
the hollow portion comprises two edge portions extending in the length direction of the mounting bracket parallel to each other, and
the reinforcing portion comprises a reinforcing rib connecting the two edge portions.

13. The fixing device according to claim 11, wherein
the reinforcement portion comprises a rib portion extending in the length direction of the mounting bracket, and in the length direction of the mounting bracket, the hollow portion and the mounting portions are located on the opposite sides of the rib portion.

14. The fixing device according to claim 13, wherein
the rib portion has a width smaller than that of the mounting portions, the supporting edges are disposed on both sides of the rib portion in the width direction of the mounting bracket, and the sum of the width of the rib portion and the width of the supporting edges on both sides is greater than or equal to the width of the mounting portions.

15. The fixing device according to claim 7, wherein the supporting edges comprise a pair of supporting edges disposed obliquely, and the pair of supporting edges extend, with the distance from each other gradually increasing, from the side edge toward the first mounting hole or away from the first mounting hole.

16. The fixing device according to claim 1, wherein the first cavity is provided with an opening at least at one end in the length direction, and the mounting bracket is detachably inserted, from the opening, in the first cavity.

17. The fixing device according to claim 1, wherein the material of the restraining member is steel.

18. The fixing device according to claim 1, wherein the restraining member is a nut, and the fixing member is a bolt.

19. A battery pack, comprising battery modules and a shell accommodating the battery modules, wherein the shell comprises a bottom plate having first cavities, and the battery module is fixed to the bottom plate by means of the fixing device according to claim 1.

20. A vehicle having the battery pack according to claim 19.
